(19) United States
(12) Patent Application Publication
(10) Pub. No.: US 2021/0358191 A1
(43) Pub. Date: Nov. 18, 2021

(54) PRECISION MODULATED SHADING

(71) Applicant: Samsung Electronics Co., Ltd., Suwon-si (KR)

(72) Inventors: Christopher P. FRASCATI, Liberty Hill, TX (US); Raun M. KRISCH, Dripping Springs, TX (US); Derek J. LENTZ, Reno, NV (US); David C. TANNENBAUM, Austin, TX (US)

(21) Appl. No.: 17/100,796

(22) Filed: Nov. 20, 2020

Related U.S. Application Data
(60) Provisional application No. 63/025,155, filed on May 14, 2020.

(51) Int. Cl. G06T 15/00

(52) U.S. Cl. CPC G06T 15/005

(57) ABSTRACT

A GPU is disclosed, which may include a VRS interface to provide spatial information and/or primitive-specific information. The GPU may include one or more shader cores including a control logic section to determine a shading precision value based on the spatial information and/or the primitive-specific information. The control logic section may modulate a shading precision according to the shading precision value. A method for controlling shading precision by a GPU may include providing, by a VRS interface, the spatial information and/or primitive-specific information. The method may include determining, by a control logic section, a shading precision value based on the spatial information and/or the primitive-specific information. The method may include modulating a shading precision according to the shading precision value.

### RELATED APPLICATION DATA

This application claims the benefit of U.S. Provisional Application Ser. No. 63/025,155, filed on May 14, 2020, which is hereby incorporated by reference.

### TECHNICAL AREA

The present disclosure relates to graphics processing, and more particularly, to precision modulated shading performed by graphics processing units (GPUs).

### BACKGROUND

Modern graphics systems may use hardware and software, which may provide common interfaces to application programmers known as application programming interfaces (APIs). The APIs may specify, in detail, how the GPU hardware performs shader operations, but may not always explicitly indicate a numeric precision to be followed. Pixel shading rate may usually be 1:1. In other words, one shader may be spawned per pixel in a render target. Multisample anti-aliasing (MSAA) may allow for more shaders per pixel with a resolve step to blend the subpixels into one final pixel. Variable rate shading (VRS) may be used because many objects are spatially consistent in color. Or, far away objects may not have the resolution for a 1:1 shading rate to be visibly noteworthy for the human eye. Shaders may be compiled at pipeline creation time and may be strongly typed. Compilers may have access only to standard types (e.g., 32 bit or 16 bit floating point types). Power is a key limiting factor of overall power, performance, area (PPA) in computing devices. When power savings are achieved, performance can increase due to allowing for increased voltage and/or frequency operating points.

### BRIEF SUMMARY

Various embodiments of the disclosure include a GPU, which may include a VRS interface configured to provide at least one of spatial information or primitive-specific information. The GPU may include one or more shader cores including a control logic section configured to determine a shading numerical precision value based on the at least one of the spatial information or the primitive-specific information. The control logic section of the one or more shader cores may be configured to modulate a shading precision according to the shading precision value.

Some embodiments may include a computer-implemented method for controlling shading precision by a GPU. The method may include providing, by a VRS interface, at least one of spatial information or primitive-specific information. The method may include determining, by a control logic section of one or more shader cores, a shading precision value based on the at least one of the spatial information or the primitive-specific information. The method may include modulating, by the control logic section of the one or more shader cores, a shading precision according to the shading precision value.

### BRIEF DESCRIPTION OF THE DRAWINGS

The foregoing and additional features and advantages of the present disclosure will become more readily apparent from the following detailed description, made with reference to the accompanying figures, in which:

FIG. 1A illustrates a block diagram of a host in communication with a GPU in accordance with some embodiments.

FIG. 1B illustrates a GPU in accordance with some embodiments.

FIG. 1C illustrates a mobile personal computer including a GPU in accordance with some embodiments.

FIG. 1D illustrates a tablet computer including a GPU in accordance with some embodiments.

FIG. 1E illustrates a smart phone including a GPU in accordance with some embodiments.

FIG. 2 illustrates a shader precision translation table in accordance with some embodiments.

FIG. 3 is a flow diagram illustrating a technique for automatically controlling and/or modulating shading precision in accordance with some embodiments.

FIG. 4 is a flow diagram illustrating another technique for automatically controlling and/or modulating shading precision in accordance with some embodiments.

FIG. 5 is a flow diagram illustrating yet another technique for automatically controlling and/or modulating shading precision in accordance with some embodiments.

### DETAILED DESCRIPTION

Reference will now be made in detail to embodiments disclosed herein, examples of which are illustrated in the accompanying drawings. In the following detailed description, numerous specific details are set forth to enable a thorough understanding of the inventive concept. It should be understood, however, that persons having ordinary skill in the art may practice the inventive concept without these specific details. In other instances, well-known methods, procedures, components, circuits, and networks have not been described in detail so as not to unnecessarily obscure aspects of the embodiments.

It will be understood that, although the terms first, second, etc. may be used herein to describe various elements, these elements should not be limited by these terms. These terms are only used to distinguish one element from another. For example, a first device could be termed a second device, and, similarly, a second device could be termed a first device, without departing from the scope of the inventive concept.

The terminology used in the description of the inventive concept herein is for the purpose of describing particular embodiments only and is not intended to be limiting of the inventive concept. As used in the description of the inventive concept and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The components and features of the drawings are not necessarily drawn to scale.

Embodiments disclosed herein include a precision modulated shading technique for reducing power consumption of devices without causing perceptible differences in graphics image quality to the human eye. This may be particularly advantageous for mobile devices such as laptop computers, smart tablets, smart phones, or the like. One or more rules can be defined and/or implemented for determining when lower precision may not have a significant difference in image quality. In accordance with embodiments disclosed herein, one or more arithmetic logic units (ALUs) of a GPU may be configured to ignore one or more fractional least significant bits (LSBs). For some algorithms, 32 bit floating point calculations may not be visually different to a human from 24 bit or 16 bit floating point calculations.

Some embodiments disclosed herein may merge a variable rate shading concept with variable precision arithmetic, using the former to control the application of the latter. Thus, in areas with higher spatial shading resolutions (e.g., a higher shading rate), higher precision arithmetic may be used, and for areas with lower spatial shading resolutions (e.g., a lower shading rate)—implying less of a focal point in an image, as per an application's discretion—lower arithmetic precision may be applied.

Power may be a key limiting factor of overall power, performance, area (PPA) in devices—particularly in mobile devices. The presently disclosed apparatus, system, and method address power limitations by selectively reducing arithmetic precision (e.g., in a power-savings manner) while avoiding image degradation due to a disclosed ability to choose to reduce precision only where resolution is already reduced. In addition, arithmetic precision may be selectively reduced where for multiple (x,y) locations, exact pixel values need not be produced, but may instead be interpolated from among their neighbors.

Because precision may be controlled by an application, there may not be a need to perform difficult or questionable heuristics to determine when, where, and to what degree that precision should be modulated. Accordingly, the presently disclosed apparatus, system, and method may be more effective than earlier attempts such as adaptive de-sampling (i.e., a spatial reduction in rendering, not a modulation of numerical precision) at power reduction. Whereas embodiments disclosed herein may be controlled by an application on a device, approaches such as adaptive de-sampling may not be controlled by the application.

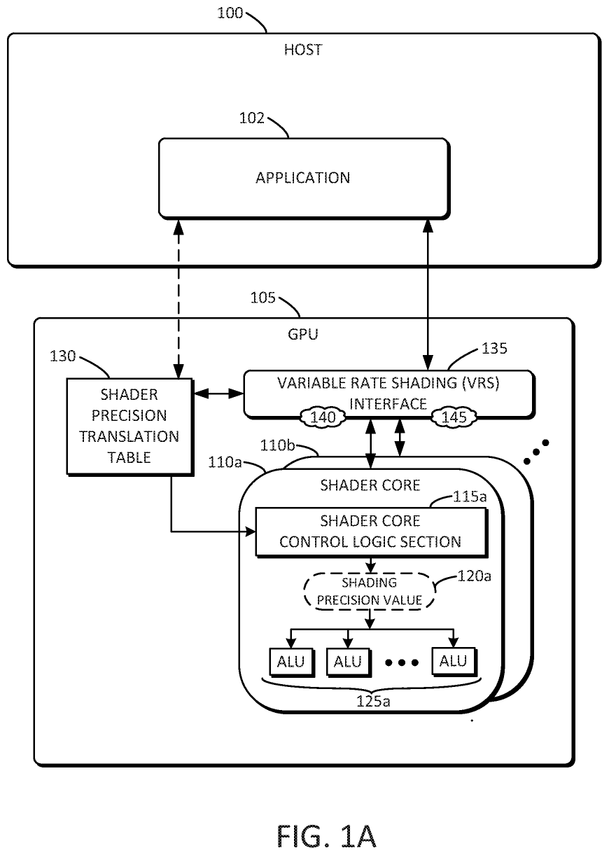

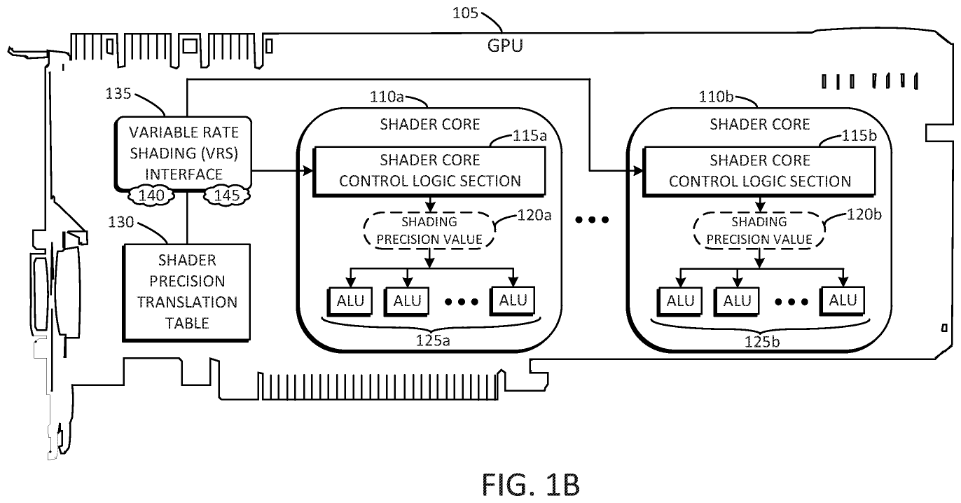

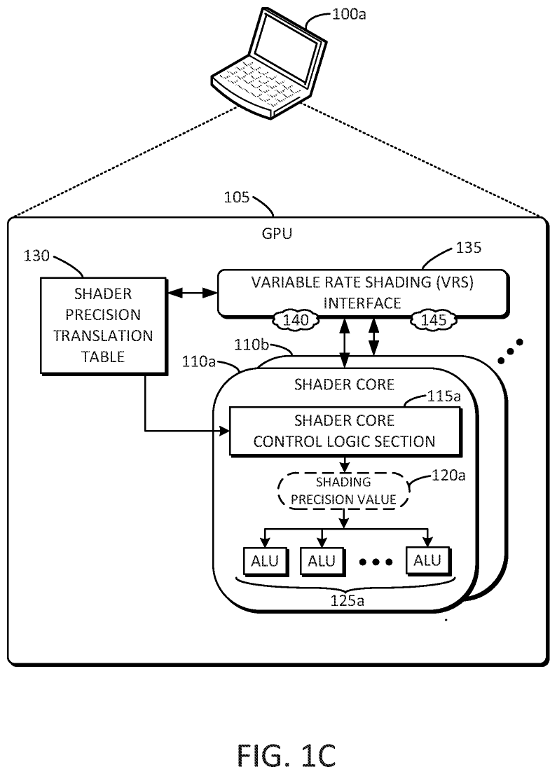

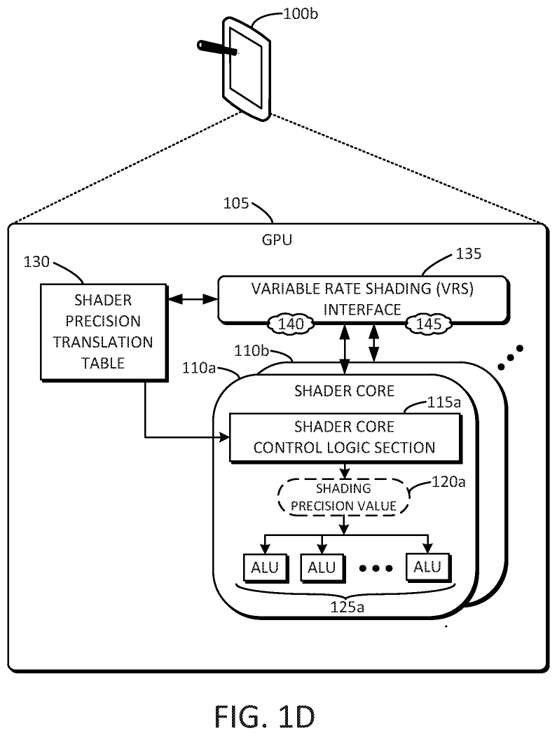

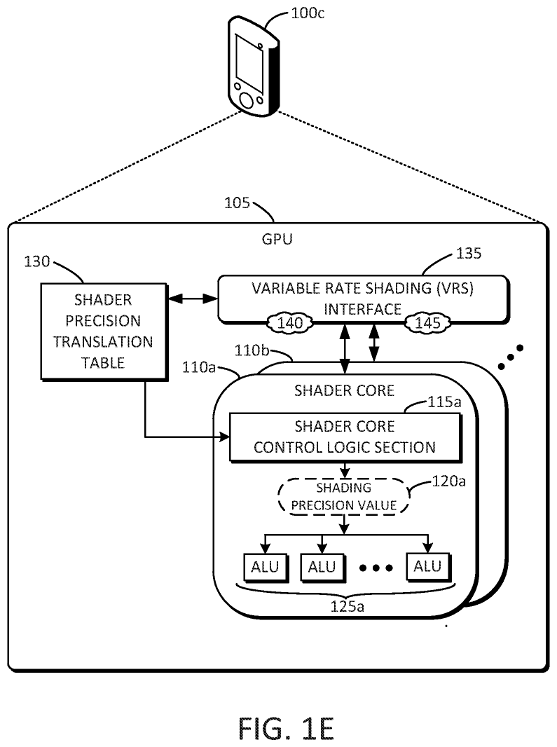

FIG. 1A illustrates a block diagram of a host 100 in communication with a GPU 105 in accordance with some embodiments. FIG. 1B illustrates a GPU 105 in accordance with some embodiments. FIG. 1C illustrates a mobile personal computer 100a including a GPU 105 in accordance with some embodiments. FIG. 1D illustrates a tablet computer 100b including a GPU 105 in accordance with some embodiments. FIG. 1E illustrates a smart phone 100c including a GPU 105 in accordance with some embodiments. Reference is now made to FIGS. 1A through 1E.

The GPU 105 may include a VRS interface 135, which may provide spatial information 140 and/or primitive-specific information 145. The VRS interface 135 may be implemented using software, firmware, hardware, or any combination thereof. The GPU 105 may include one or more shader cores (e.g., 110a, 110b) including a control logic section (e.g., 115a, 115b as shown in FIG. 1B), which may determine a shading precision value (e.g., 120a) based on the spatial information 140 and/or the primitive-specific information 145. The one or more shader cores (e.g., 110a, 110b) and the control logic section (e.g., 115a, 115b) may be implemented using software, firmware, hardware, or any combination thereof. The control logic section (e.g., 115a, 115b) of the one or more shader cores (e.g., 110a, 110b) may modulate a shading precision of the GPU 105 according to the shading precision value (e.g., 120a). The control logic section (e.g., 115a, 115b) of the one or more shader cores (e.g., 110a, 110b) may reduce the shading precision of the GPU 105 based on the shading rate value (e.g., 120a) having a relatively low value, and may increase the shading precision of the GPU 105 based on the shading rate value (e.g., 120a) having a relatively high value. Put differently, the control logic section (e.g., 115a, 115b) of the one or more shader cores (e.g., 110a, 110b) may conditionally decrease the precision in certain instances. The GPU 105 may include a shader precision translation table 130. In some embodiments, the shader precision translation table 130 is a logical construct or data structure, which may be implemented as software or firmware, for example. An application 102 associated with the host 100 may communicate with the GPU 105. The application 102 can include, for example, software or firmware that is executable on hardware associated with the host 100. For example, the application 102 may communicate with the VRS interface 135, or may change one or more values of the shader precision translation table 130, or the like. In some embodiments, the application 102 may control a shader precision by modifying one or more entries in the shader precision translation table 130. In some embodiments, the application 102 may directly provide a shading precision value (e.g., 120a) to the GPU 105.

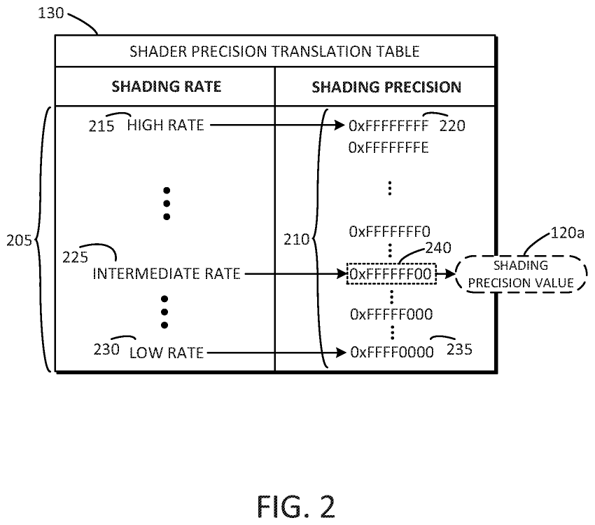

FIG. 2 illustrates additional details of the shader precision translation table 130 in accordance with some embodiments. Reference is now made to FIGS. 1A through 2.

The shader precision translation table 130 may include one or more shading rate values 205, and one or more shading precision values 210. A relatively high shading rate (e.g., 215) may correspond to a relatively precise shading precision value (e.g., 220). A relatively low shading rate (e.g., 230) may correspond to a relatively imprecise shading precision value (e.g., 235). An intermediate shading rate (e.g., 225) may correspond to an intermediate shading precision value (e.g., 240). The control logic section (e.g., 115a, 115b) of the one or more shader cores (e.g., 110a, 110b) may select (e.g., 120a) a shading precision value (e.g., 240) based on the one or more shading rate values (e.g., 225). The shader precision translation table 130 may include a default set of the one or more shading rate values 205, and a default set of the one or more shading precision values 210. The default set of the one or more shading precision values 205 may be changed the by application 102 and/or by the control logic section (e.g., 115a, 115b) of the one or more shader cores (e.g., 110a, 110b).

The control logic section (e.g., 115a, 115b) of the one or more shader cores (e.g., 110a, 110b) may cause one or more ALUs (e.g., 125a) to perform one or more floating point operations at a precision that is based on the selected one or more shading precision values (e.g., 120a). In some embodiments, the VRS interface 135 may select the one or more shading precision values (e.g., 120a) based on the one or more shading rate values (e.g., 225), and the control logic section (e.g., 115a, 115b) of the one or more shader cores (e.g., 110a, 110b) may receive the selected one or more shading precision values (e.g., 120a) from the VRS interface 135.

The control logic section (e.g., 115a, 115b) of the one or more shader cores (e.g., 110a, 110b) may cause the one or more ALUs (e.g., 125a) to perform one or more floating point operations at a precision that is based on the selected one or more shading precision values (e.g., 120a). In other words, the one or more ALUs (e.g., 125a) may ignore one or more fractional LSBs.

The spatial information 140 and/or the primitive-specific information 145 provided via the VRS interface 135 may be used advantageously to control shading precision. Various precisions may be supported, allowing more than the traditional 32 bit floating point or 16 bit floating point choices, and may correspond to a granularity of spatial shading provided by a VRS implementation. Advantageously, power can be reduced by using lower-precision arithmetic for certain computations. The embodiments disclosed herein do not require difficult and/or subjective guesses or heuristics for when to apply precision reductions. Hardware changes may be highly localized, and thus easier to implement and easier to verify. Minimal software and/or hardware changes may be needed. There is no or very little (i.e., imperceptible) quality degradations. When power savings is sufficient, performance can increase due to allowing for increased frequency operating points, which may depend on an increased voltage. In other words, the frequency can be increased because there may be more margin with respect to a power ceiling.

In shader core floating-point data paths, control may be augmented to contain a precision selection field (e.g., shading precision value 120a) of one or more bits based on an implementation decision of how fine the precision granularity should be. In the case of vertex shaders, this field (e.g., 120a) may be derived from primitive stream VRS controls provided by the application 102, and these may then be passed to shader logic. This may be accomplished without any driver modification. When the VRS rate changes within a draw call, then potentially finer control may be needed for precision due to threads corresponding to different primitives with different precision requirements packed into a same wave. The hardware may choose a most conservative (e.g., highest precision) thread among threads when there are differing requirements.

In a graphics pipeline, new per-primitive state may be added to record the particular precision setting for a given primitive such that upon rasterization and subsequent dispatch to a pixel shader (e.g., 110a, 110b), an appropriate precision (e.g., 120a) can be applied. In a manner analogous to vertices, when multiple precisions are needed for pixels in the same wave, some embodiments disclosed herein may opt for the highest precision needed among the pixels, and/or provide for finer granularity.

The ALUs (e.g., 125a) and/or floating-point units may be modified to honor new control bits selecting various internal intermediate precision levels. In some embodiments, opportunistic clock gating in and around the ALUs (e.g., 125a) and/or floating-point units may be performed when precision is reduced. Additionally, numerical conversion units may have their output precisions reduced when feeding to a unit operating at reduced precision.

In some embodiments, using a VRS mechanism, the precision of the ALUs (e.g., 125a) may be modulated by ignoring N LSBs. The N LSBs may be forced to zero (0), or alternatively, kept unmodified. In some embodiments, the N LSBs may be ignored in any static random access memory (SRAM) writes, memory cache writes, and/or any operations downstream of the shader. Following is an example pseudo-code implementation in which the 8 LSBs may be forced to zero as a form of ignoring them.

A compiler can produce the following code:

fadd dst, src0, src1

In some embodiments, the above line is used, but the numerical result may be as if the following lines were executed and the resulting power reduction achieved. The following lines represent how the code can be modified to simulate an effect of reducing the numerical precision—in this example, a reduced precision calculation for a floating-point add operation.

| | |
|---|---|
| and src0Tmp, src0, 0xffffff00 | // ignore 8 LSBs of src0 |
| and src1Tmp, src1, 0xffffff00 | // ignore 8 LSBs of src1 |
| fadd dstTmp, src0Tmp, src1Tmp | // operate with out LSBs |
| and dstLSBs, dst, 0x000000ff | // keep 8 LSBs of dst |

| | |
|---|---|
| or dst, dstTmp, dstLSBs | // merge LSBs of dst with result of operation |

In this example, 24 bits are used in a shader operation (e.g., within a shader core), in a register write, or the like. Accordingly, floating point precision of calculations may be reduced automatically as the shading rate is reduced. The application 102 need not be aware that shading precision is reduced to 24 bits. In other words, the application layer may “think” that operations are being performed at a shading precision of 32 bits, even though they are being performed at a shading precision of 24 bits. In some embodiments, the shading precision value may be tunable at a hardware level.

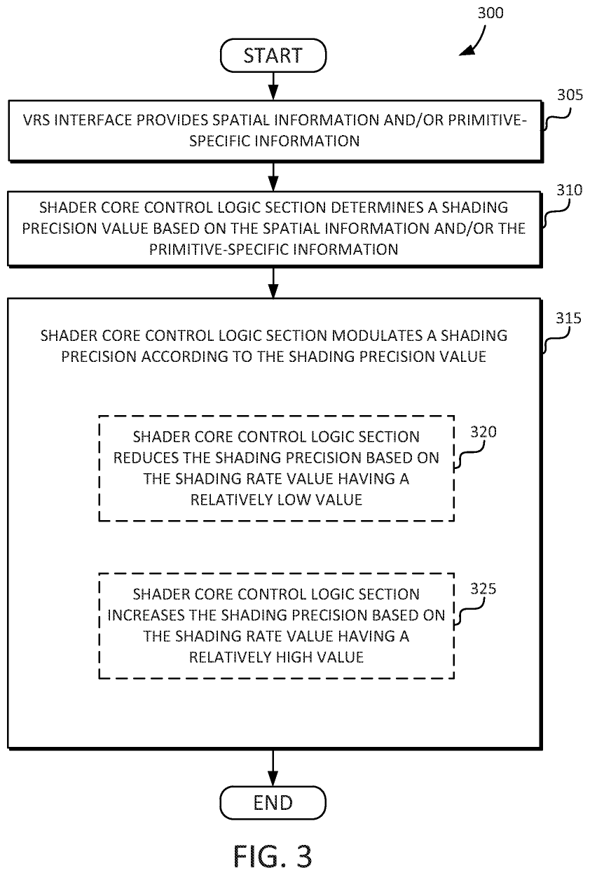

FIG. 3 is a flow diagram 300 illustrating a technique for automatically controlling and/or modulating shading precision in accordance with some embodiments. Reference is now made to FIGS. 1A through 3.

At 305, the VRS interface 135 may provide spatial information 140 and/or or primitive-specific information 145. At 310, the control logic section (e.g., 115a, 115b) of the one or more shader cores (e.g., 110a, 110b) may determine a shading precision value (e.g., 120a) based on the spatial information 140 and/or the primitive-specific information 145. At 315, the control logic section (e.g., 115a, 115b) of the one or more shader cores (e.g., 110a, 110b) may modulate a shading precision of the GPU 105 according to the shading precision value (e.g., 120a). For example, at 320, the control logic section (e.g., 115a, 115b) of the one or more shader cores (e.g., 110a, 110b) may reduce the shading precision of the GPU 105 based on the shading rate value (e.g., 230) having a relatively low value. By way of another example, at 325, the control logic section (e.g., 115a, 115b) of the one or more shader cores (e.g., 110a, 110b) may increase the shading precision of the GPU 105 based on the shading rate value (e.g., 215) having a relatively high value.

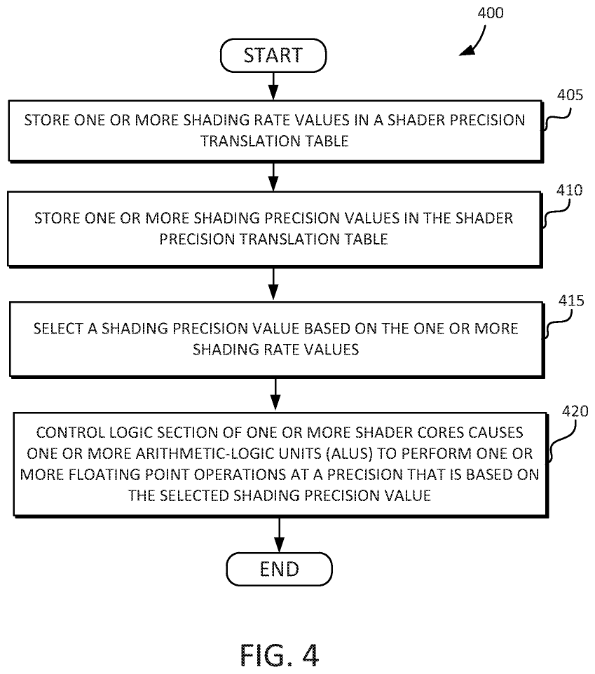

FIG. 4 is a flow diagram 400 illustrating a technique for automatically controlling and/or modulating shading precision in accordance with some embodiments. Reference is now made to FIGS. 1A through 2, and 4.

At 405, one or more shading rate values 205 may be stored in the shader precision translation table 130. At 410, one or more shading precision values 210 may be stored in the shader precision translation table 130. It will be understood that the values 205 and 210 may be stored in the shader precision translation table 130 in a single operation, or in any order. At 415, the control logic section (e.g., 115a, 115b) of the one or more shader cores (e.g., 110a, 110b) may select a shading precision value (e.g., 120a) based on the one or more shading rate values 210. At 420, the control logic section (e.g., 115a, 115b) of the one or more shader cores (e.g., 110a, 110b) may cause the one or more ALUs (e.g., 125a) to perform one or more floating point operations at a precision that is based on the selected shading precision value (e.g., 120a).

In some embodiments, the VRS interface 135 may select the shading precision value (e.g., 120a) based on the one or more shading rate values 205. The control logic section (e.g., 115a, 115b) of the one or more shader cores (e.g., 110a, 110b) may receive the selected shading precision value (e.g., 120a) from the VRS interface 135, and may cause the one or more ALUs (e.g., 125a) to perform one or more floating point operations at a precision that is based on the selected shading precision value (e.g., 120a).

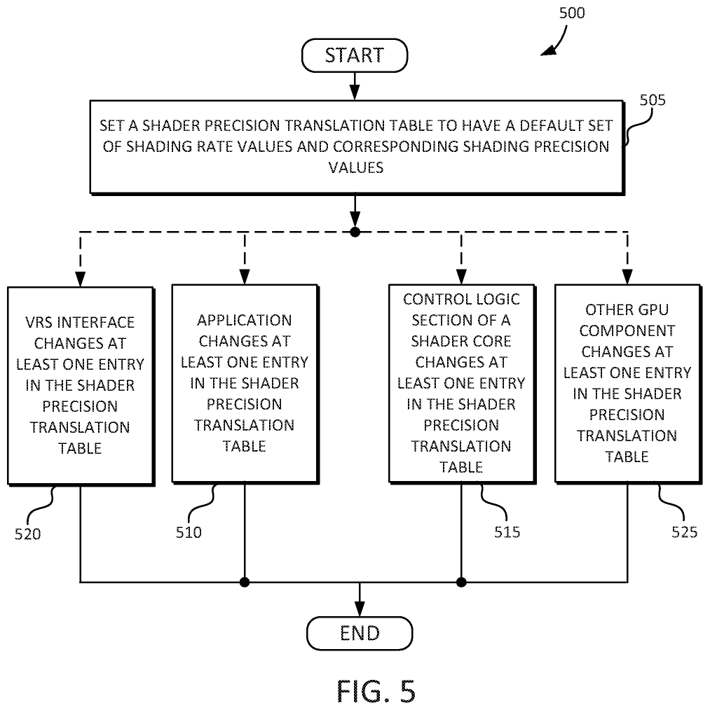

FIG. 5 is a flow diagram 500 illustrating a technique for automatically controlling and/or modulating shading precision in accordance with some embodiments. Reference is now made to FIGS. 1A through 2, and 5.

At 505, the precision translation table 130 may be set to have a default set of shading rate values 205 and corresponding shading precision values 210. At 510, the application 102 may change at least one entry in the precision translation table 130. Alternatively or in addition, at 515, the control logic section (e.g., 115a, 115b) of the one or more shader cores (e.g., 110a, 110b) may change at least one entry in the precision translation table 130. Alternatively or in addition, at 520, the VRS interface 135 may change at least one entry in the precision translation table 130. Alternatively or in addition, at 525, another component of the GPU 105 may change at least one entry in the precision translation table 130.

In some embodiments, more precisions than what are shown in the example precision translation table 130 may be used. In some embodiments, when VRS is controlled at a primitive level, precision can be modulated in one or more front-end shaders in addition to pixel shaders.

Some embodiments disclosed herein include a GPU having a VRS interface that may be configured to provide at least one of spatial information or primitive-specific information. The GPU may include one or more shader cores including a control logic section configured to determine a shading precision value based on the at least one of the spatial information or the primitive-specific information. In some embodiments, the control logic section of the one or more shader cores is configured to modulate a shading precision according to the shading precision value.

In some embodiments, the control logic section of the one or more shader cores is configured to reduce the shading precision based on the shading rate value having a relatively low value. In some embodiments, the control logic section of the one or more shader cores is configured to increase the shading precision based on the shading rate value having a relatively high value.

The GPU may include a shader precision translation table. In some embodiments, the shader precision translation table includes one or more shading rate values and one or more shading precision values. In some embodiments, the control logic section of the one or more shader cores is configured to select the one or more shading precision values based on the one or more shading rate values. In some embodiments, the control logic section of the one or more shader cores is configured to cause one or more ALUs to perform one or more floating point operations at a precision that is based on the selected one or more shading precision values. In some embodiments, the VRS interface is configured to select the one or more shading precision values based on the one or more shading rate values. In some embodiments, the control logic section of the one or more shader cores is configured to receive the selected one or more shading precision values from the VRS interface. In some embodiments, the control logic section of the one or more shader cores is configured to cause one or more ALUs to perform one or more floating point operations at a precision that is based on the selected one or more shading precision values.

In some embodiments, the shader precision translation table includes a default set of the one or more shading rate values, and a default set of the one or more shading precision values. In some embodiments, the default set of the one or more shading precision values is configured to be changed by at least one of an application or the control logic section of the one or more shader cores.

Some embodiments disclosed herein include a computer-implemented method for controlling shading precision by a GPU. The method may include providing, by VRS interface, at least one of spatial information or primitive-specific information. The method may include determining, by a control logic section of one or more shader cores, a shading precision value based on the at least one of the spatial information or the primitive-specific information. The method may include modulating, by the control logic section of the one or more shader cores, a shading precision according to the shading precision value.

In some embodiments, the method may include reducing, by the control logic section of the one or more shader cores, the shading precision based on the shading rate value having a relatively low value. The method may include increasing, by the control logic section of the one or more shader cores, the shading precision based on the shading rate value having a relatively high value.

In some embodiments, the GPU includes a shader precision translation table. The method may include modulating, by the control logic section of the one or more shader cores, the shading precision based on the shader precision translation table. The method may include storing one or more shading rate values and one or more shading precision values in the shader precision translation table. The method may include selecting, by the control logic section of the one or more shader cores, the one or more shading precision values based on the one or more shading rate values.

The method may include causing, by the control logic section of the one or more shader cores, one or more arithmetic logic units (ALUs) to perform one or more floating point operations at a precision that is based on the selected one or more shading precision values. The method may include selecting, by the VRS interface, the one or more shading precision values based on the one or more shading rate values. The method may include receiving, by the control logic section of the one or more shader cores, the selected one or more shading precision values from the VRS interface. The method may include causing, by the control logic section of the one or more shader cores, one or more ALUs to perform one or more floating point operations at a precision that is based on the selected one or more shading precision values.

The method may include setting the shader precision translation table to have a default set of the one or more shading rate values, and a default set of the one or more shading precision values. The method may include changing, by at least one of an application or the control logic section of the one or more shader cores, the default set of the one or more shading precision values of the shader precision translation table.

The blocks or steps of a method or algorithm and functions described in connection with the embodiments disclosed herein may be embodied directly in hardware, in a software module executed by a processor, or in a combination of the two. Modules may include hardware, software, firmware, or any combination thereof. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

The following discussion is intended to provide a brief, general description of a suitable machine or machines in which certain aspects of the inventive concept can be implemented. Typically, the machine or machines include a system bus to which is attached processors, memory, e.g., RAM, ROM, or other state preserving medium, storage devices, a video interface, and input/output interface ports. The machine or machines can be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, a virtual machine, or a system of communicatively coupled machines, virtual machines, or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine or machines can include embedded controllers, such as programmable or non-programmable logic devices or arrays, ASICs, embedded computers, cards, and the like. The machine or machines can utilize one or more connections to one or more remote machines, such as through a network interface, modem, or other communicative coupling. Machines can be interconnected by way of a physical and/or logical network, such as an intranet, the Internet, local area networks, wide area networks, etc. One skilled in the art will appreciate that network communication can utilize various wired and/or wireless short range or long range carriers and protocols, including radio frequency (RF), satellite, microwave, Institute of Electrical and Electronics Engineers (IEEE) 545.11, Bluetooth®, optical, infrared, cable, laser, etc.

Embodiments of the present disclosure can be described by reference to or in conjunction with associated data including functions, procedures, data structures, application programs, etc. which when accessed by a machine results in the machine performing tasks or defining abstract data types or low-level hardware contexts. Associated data can be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, etc. Associated data can be delivered over transmission environments, including the physical and/or logical network, in the form of packets, serial data, parallel data, propagated signals, etc., and can be used in a compressed or encrypted format. Associated data can be used in a distributed environment, and stored locally and/or remotely for machine access.

Having described and illustrated the principles of the present disclosure with reference to illustrated embodiments, it will be recognized that the illustrated embodiments can be modified in arrangement and detail without departing from such principles, and can be combined in any desired manner. And although the foregoing discussion has focused on particular embodiments, other configurations are contemplated. In particular, even though expressions such as “according to an embodiment of the inventive concept” or the like are used herein, these phrases are meant to generally reference embodiment possibilities, and are not intended to limit the inventive concept to particular embodiment configurations. As used herein, these terms can reference the same or different embodiments that are combinable into other embodiments.

Embodiments of the present disclosure may include a non-transitory machine-readable medium comprising instructions executable by one or more processors, the instructions comprising instructions to perform the elements of the inventive concepts as described herein.

The foregoing illustrative embodiments are not to be construed as limiting the inventive concept thereof. Although a few embodiments have been described, those skilled in the art will readily appreciate that many modifications are possible to those embodiments without materially departing from the novel teachings and advantages of the present disclosure. Accordingly, all such modifications are intended to be included within the scope of this present disclosure as defined in the claims.

What is claimed is:

1. A graphics processing unit (GPU), comprising:
a variable rate shading (VRS) interface configured to provide at least one of spatial information or primitive-specific information; and
one or more shader cores including a control logic section configured to determine a shading precision value based on the at least one of the spatial information or the primitive-specific information,
wherein the control logic section of the one or more shader cores is configured to modulate a shading precision according to the shading precision value.

2. The GPU of claim 1, wherein the control logic section of the one or more shader cores is configured to change the shading precision based on a change of the shading rate value.

3. The GPU of claim 1, further comprising a shader precision translation table.

4. The GPU of claim 3, wherein the shader precision translation table comprises:
one or more shading rate values; and
one or more shading precision values.

5. The GPU of claim 4, wherein the control logic section of the one or more shader cores is configured to select the one or more shading precision values based on the one or more shading rate values.

6. The GPU of claim 5, wherein the control logic section of the one or more shader cores is configured to cause one or more arithmetic logic units (ALUs) to perform one or more floating point operations at a precision that is based on the selected one or more shading precision values.

7. The GPU of claim 4, wherein the VRS interface is configured to select the one or more shading precision values based on the one or more shading rate values.

8. The GPU of claim 7, wherein the control logic section of the one or more shader cores is configured to receive the selected one or more shading precision values from the VRS interface.

9. The GPU of claim 8, wherein the control logic section of the one or more shader cores is configured to cause one or more ALUs to perform one or more floating point operations at a precision that is based on the selected one or more shading precision values.

10. The GPU of claim 1, wherein:
the shader precision translation table includes a default set of the one or more shading rate values, and a default set of the one or more shading precision values; and
the default set of the one or more shading precision values is configured to be changed by at least one of an application or the control logic section of the one or more shader cores.

11. A computer-implemented method for controlling shading precision by a graphics processing unit (GPU), the method comprising:
providing, by a variable rate shading (VRS) interface, at least one of spatial information or primitive-specific information;
determining, by a control logic section of one or more shader cores, a shading precision value based on the at least one of the spatial information or the primitive-specific information; and
modulating, by the control logic section of the one or more shader cores, a shading precision according to the shading precision value.

12. The computer-implemented method of claim 11, further comprising changing, by the control logic section of the one or more shader cores, the shading precision based on a change of the shading rate value.

13. The computer-implemented method of claim 11, wherein the GPU includes a shader precision translation table, and the method further comprises modulating, by the control logic section of the one or more shader cores, the shading precision based on the shader precision translation table.

14. The computer-implemented method of claim 13, further comprising:
storing one or more shading rate values and one or more shading precision values in the shader precision translation table; and
selecting, by the control logic section of the one or more shader cores, the one or more shading precision values based on the one or more shading rate values.

15. The computer-implemented method of claim 14, further comprising causing, by the control logic section of the one or more shader cores, one or more arithmetic logic units (ALUs) to perform one or more floating point operations at a precision that is based on the selected one or more shading precision values.

16. The computer-implemented method of claim 13, further comprising selecting, by the VRS interface, the one or more shading precision values based on the one or more shading rate values.

17. The computer-implemented method of claim 16, further comprising receiving, by the control logic section of the one or more shader cores, the selected one or more shading precision values from the VRS interface.

18. The computer-implemented method of claim 17, further comprising causing, by the control logic section of the one or more shader cores, one or more ALUs to perform one or more floating point operations at a precision that is based on the selected one or more shading precision values.

19. The computer-implemented method of claim 18, further comprising gating one or more clocks based on the one or more ALUs performing the one or more floating point operations at the precision that is based on the selected one or more shading precision values.

20. The computer-implemented method of claim 11, further comprising:
setting the shader precision translation table to have a default set of the one or more shading rate values, and a default set of the one or more shading precision values; and
changing, by at least one of an application or the control logic section of the one or more shader cores, the default set of the one or more shading precision values of the shader precision translation table.
